(19) United States
(12) Patent Application Publication
(10) Pub. No.: US 2015/0058086 A1
(43) Pub. Date: Feb. 26, 2015

(54) DETERMINING COST TO SERVE FOR A CONSUMER PACKAGED GOODS COMPANY

(71) Applicant: Tata Consultancy Services Limited, Mumbai (IN)

(72) Inventors: Nilesh Ashok JOSHI, Bangalore (IN); Harish Kumar GUNTUKU, Bangalore (IN); Ankit Kumar JAIN, Noida (IN)

(21) Appl. No.: 14/205,237

(22) Filed: Mar. 11, 2014

(30) Foreign Application Priority Data
Aug. 23, 2013 (IN) 2766/MUM/2013

(51) Int. Cl. G06Q 30/02

(52) U.S. Cl. CPC G06Q 30/0204
USPC 705/7.33

(57) ABSTRACT

The present subject matter discloses system(s) and computer-implemented method(s) for determining total cost to serve (CTS) a product to a customer of a consumer packaged goods (CPG) company. The computer-implemented method includes identifying a total cost associated with the product and incurred by the CPG company in each of a plurality of organizational functions of the CPG company; allocating cost attributable to the customer for the one or more activities under each of the plurality of organizational functions; computing a CTS value for each of the plurality of organizational functions based on the allocated cost attributable to the customer; and determining the total CTS of the product served to the customer. The total cost is retrieved from a database. The allocation is based on predefined allocation criteria and the determination includes summing up the CTS values for each of the plurality of organizational functions.

### TECHNICAL FIELD

The present subject matter relates, in general, to determination of cost to serve and particularly to determination of cost to serve for a consumer packaged goods (CPG) company.

### BACKGROUND

Companies, such as consumer packaged goods (CPG) companies, serve, i.e., make their products available to, a variety of customers, such as distributors and retailers. To serve the products to the customers, the CPG companies perform a series of functions and activities which incur costs. These functions and activities are performed such that the products are served to the customers at minimal cost while maintaining the quality of the products. The CPG companies may adopt different methodologies to remain competitive and to provide products at reasonable prices. These methodologies may enable the CPG companies to identify customers for whom the cost to serve is relatively less, and in reducing the costs of serving customers.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer features and components.

FIG. 1 illustrates a network environment implementing a cost to serve determination system, in accordance with an embodiment of the present subject matter.

FIG. 2 illustrates a method for determining cost to serve for a customer, in accordance with an implementation of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computing device or processor, whether or not such computing device or processor is explicitly shown.

### DETAILED DESCRIPTION

The subject matter disclosed herein relates to system(s) and method(s) for determining a total cost of serving a product to a customer. The cost incurred in serving, i.e., making available, a product to a customer is referred to as a cost-to-serve (CTS) of the product served to the customer. For the purposes of the present subject matter, the product may include goods related to a consumer packaged goods (CPG) company. The products may include food, beverages, and other consumer packaged goods. Further, the customer may include a distributor and a retailer. Furthermore, the CPG company may include a company that serves fast moving consumer products having high demand, low cost, and frequent consumption. The CPG company may be referred to as a fast moving consumer goods (FMCG) company.

Generally, CPG companies are under constant pressure for serving their products to customers because of, for example, increase in competition between the CPG companies, increase in customer demands, presence of private labels, such as of equivalent products of retailers' own brands, volatile prices of raw materials, changing needs and preferences, brand management, and strengthening relationship with the customers. Therefore, the CPG companies work towards new ways to remain competitive. In view of the above, the CPG companies may, at regular intervals, analyze the CTS of a product served to a customer.

Typically, to estimate and analyze the cost of serving the product to the customer, data is obtained for the CPG company as a whole, for a predefined time period, for example, half-yearly data or yearly data. The data may relate to total cost involved in performing activities under various organizational functions, such as distribution, sales and invoicing of the CPG company. This data may be analyzed to evaluate the CTS of the product served to the customer. However, the evaluated CTS may not provide details at granular level, and may not provide analyses and insights into how and where the costs were incurred, which customers and channels are profitable to the CPG company, and the like. For example, for serving the product to the customer, the CPG company may perform a plurality of activities associated with the organizational functions of the CPG company. Conventional evaluation methods may not provide cost details based on the activities performed under each of the organizational functions. In addition, the CTS evaluated for the products may lack contribution from certain functions of the CPG company. This may introduce errors in the CTS evaluation, or the evaluation of CTS may be incomplete. Also, the CPG companies may have to invest a substantial amount of time and money with the conventional evaluation methods for the estimation and analysis of the CTS for the product.

Further, the conventional evaluation methods are carried out on the basis of product categories. The evaluation of the CTS on the product category basis may include costs incurred by the CPG company in serving all the customers for that product category. As a result of this, it may be difficult to obtain profitability of an individual customer or to conduct customer level profit-loss analysis. This therefore may not allow the CPG companies to identify and segment customers between profitable and non-profitable customers.

As mentioned above, the conventional evaluation methods may provide the CTS based on the data obtained from the CPG company. A user, such as an administrator, or a business user, may get the CTS based on the retrieved data and based on present day costs. With the conventional evaluation methods, the user may not be able to study the effect of varying the data, and may not be able to explore alternate options under the organizational functions which may induce low cost, and thus reduce the CTS. For example, the user may wish to find a less costly distribution mode for reducing the CTS associated with distribution. Thus, the conventional CTS evaluation methods may not allow the CPG company to determine ways of achieving reduced CTS of products served to the customer.

Further, there may be situations where, while evaluating the CTS, the conventional evaluation methods may consider the same cost under different organizational functions. For example, if the CPG company is employing a third party logistics company for transportation and warehousing activities, the conventional evaluation methods may consider the cost for transportation and warehousing activities under the company's own distribution function and also under a third party logistic function. This may result in redundant data being taken into consideration while evaluating the CTS, which may further cause errors in CTS evaluations, thereby resulting in wrong decisions being made by the CPG company.

The present subject matter describes system(s) and method(s) for determining total cost to serve a product to a customer associated with a CPG company. The CPG company may perform a plurality of organizational functions for serving its products to customers. The organizational functions relevant for determining the CTS for a product may be understood as the functions that incur effort and cost for serving the product to the customer. In an implementation, the plurality of organizational functions may include, but is not limited to, procurement of raw materials, manufacturing, distribution and logistics, and sales and promotion of the product. To carry out at least one functionality associated with these organizational functions, the CPG company may perform one or more activities, such as specification detailing, approvals, confirmations, and equipment renting. The CPG companies may determine costs incurred in carrying out such activities based on costing methodologies, such as activity-based costing (ABC). The ABC refers to a process of identifying and classifying processes carried out by companies, breaking the processes into activities, identifying resources consumed in performing the activities, determining costs of the activities, assigning the costs to the products and determining total cost of the products. The ABC method provides total cost based on cost of performing each activity per unit of the product.

The CTS determination system, in accordance with the present subject matter, may facilitate a user to provide an input in the form of a customer name, or a product description, and a time period, for which the total CTS is to be determined. Based on the input, the CTS determination system may identify the one or more activities under the organizational functionalities, carried out by the CPG company during that time period with respect to the customer and the product served to the customer. The CTS determination system may then retrieve data related to the one or more activities performed for the product for that period of time from a database. The CTS determination system may then determine a total cost of performing the one or more activities associated with the product. It will be understood that based on the cost associated with the one or more activities, the cost associated with each of the plurality of organizational functions that are relevant for computing the CTS may be obtained. In an implementation, the total cost may be one of a variable cost and a fixed cost. The variable cost may be understood as the cost which varies with output, such as change in number of units of products and the fixed cost may be understood to be the cost which remains substantially the same with variations in the output, such as the change in the number of the units of products.

In an implementation, based on the total cost, cost attributable to the customer for the product under one or more activities of the organizational functions may be allocated, and a CTS value may be computed for each of the plurality of organizational functions. The allocation may be based on predefined allocation criteria for the product and the customer. Further, in an implementation, a reduced CTS value may be computed for one or more of the plurality of organizational functions through what-if scenarios provided and performed by the user. A what-if scenario may be understood as a scenario created by the user to check what is the CTS if a cost-incurring attribute of the organizational function is varied. The user may provide an input to vary the cost-incurring attribute, for example, a particular raw material or its quantity selected for procurement, or number of pallets and eaches for warehousing, number of stores served, and number of shelves per store. The cost-incurring attribute may also relate to the manner in which a particular activity is performed, for example, mode of manufacturing the product. It may be noted that the CTS may be reduced based on what-if scenario provided by the user, such that the CPG company serves the product to the customer in concurrence with its contractual obligations. In other words, the what-if scenario is provided to reduce the CTS, without compromising on the contractual obligations of the CPG company to the customer. The contractual obligation may include various clauses that define and set the rules and guidelines for serving the product to customer. The clauses may include, for example, delivering or replenishing the product at a predefined frequency, delivering a minimum quantity of product per delivery, serving a predefined minimum number of stores, and such. The user may utilize the what-if scenarios based on the needs and may compute and decide on a reduced CTS value in real-time. For example, the what-if scenario may be created for the warehousing-finished goods, and/or the bill of materials. The former may help the CPG company in determining a reduced labor allocation cost for warehousing of the finished goods, and the latter may help the CPG company in determining a cost effective raw material substitute. Further, based on the CTS values, including the reduced CTS, for all the organizational functions relevant for computing the CTS, the total CTS of the product served to the customer of the CPG company may be determined.

In an implementation, the present subject matter may allow checking for relevancy or duplication of data that has been retrieved from the database. For example, if same data has been captured under different organizational functions, the CTS determination system may remove the redundant data such that the CTS determination may be accurate. Accordingly, duplication in the data may be removed. Further, based on the CTS value of each of the organizational functions, a total CTS is computed for the customer of the product.

In another implementation, the present subject matter may forecast the CTS of the product for the customer for a time period in future based on a predefined forecasting model. In an implementation, the predefined forecasting model may include, but is not limited to, a moving average model, a winter's model, and a causal model. The forecasting of the CTS may facilitate the CPG company, for example, to determine the future CTS of the products to various customers, to identify profitable customers, to design pricing strategy for future, to monitor the future expected CTS, and to reduce hidden costs. This may remove forecasting errors present in the conventional evaluation methods which forecast costs based on sales and/or profit margins.

Further, the present subject matter may provide dynamic insights into the CTS of the customer by generating dashboards. The dashboards may graphically and tabularly represent changing trends in CTS; CTS break-up among different organizational functions of the CPG company; comparison of multiple customers based on CTS revenue ratio; comparison of the multiple customers based on the total CTS; and the like.

The present subject matter may enable users to customize the data as provided for CTS determination according to their requirements. For example, the user may customize the predefined allocation criteria, the one or more activities associated with the at least one functionality of the organizational functions relevant for computing the CTS, the time period for which the total CTS is to be determined, and the like. This facilitates the CPG company in saving time and money that need to be invested in the conventional methodologies involving a consulting firm. The present subject matter may consider a product-customer combination and considers the organizational functions of the CPG company, as described earlier, for the determination of the total CTS. This facilitates in determining the CTS substantially accurately and comprehensively for individual customers and individual products. This may in turn ensure an accurate identification of profitable and non-profitable customers.

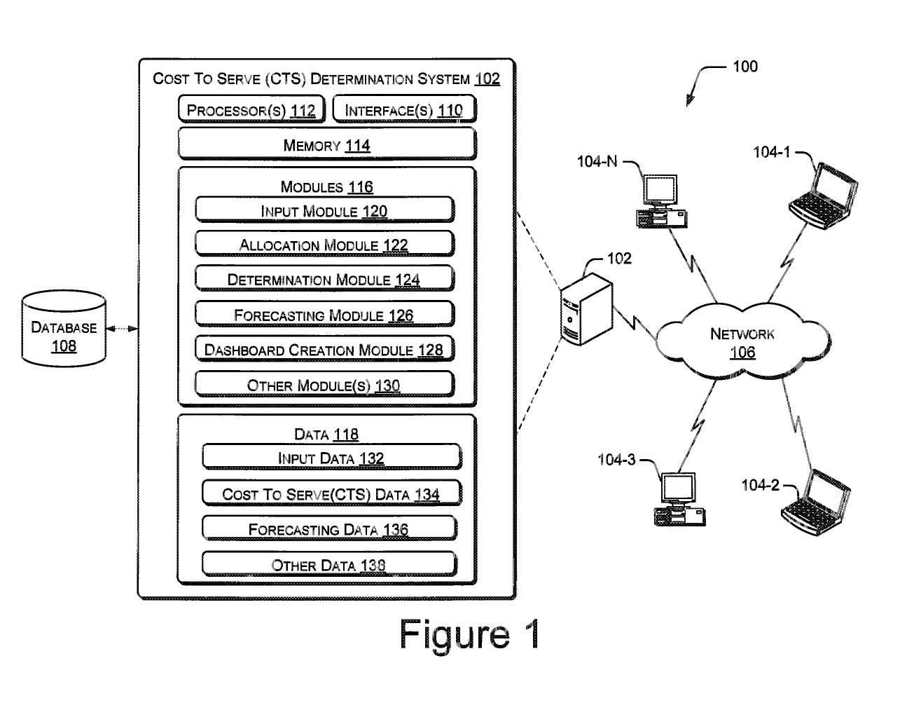

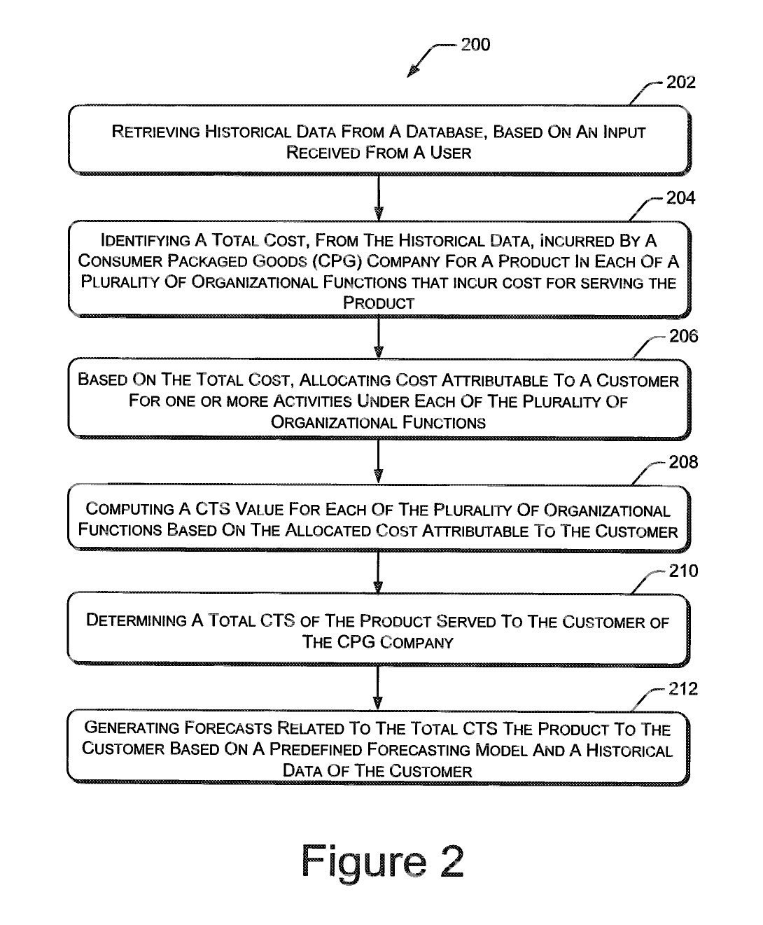

The manner in which the system(s) and method(s) shall be implemented has been explained in details with respect to FIG. 1 and FIG. 2. Although the description herein is with reference to personal computer(s), the method(s) and system(s) may be implemented in other computing device(s) as well, albeit with a few variations, as will be understood by a person skilled in the art. While aspects of described methods can be implemented in any number of different computing devices, transmission environments, and/or configurations, the implementations are described in the context of the following computing device(s).

FIG. 1 illustrates a network environment 100 implementing a CTS determination system 102, in accordance with an implementation of the present subject matter. In the implementation, the network environment 100 includes the CTS determination system 102 configured to determine a total CTS of a product of a company, served to a customer of the company. In one implementation, the network environment 100 may be a company network, including office personal computers, laptops, various servers, such as blade servers, and other computing devices. Examples of a company may include consumer packed goods (CPG) company, also referred to as a fast-moving consumer goods company. It will also be appreciated by a person skilled in the art that the company may be any company involved in any line of business related to consumer packaged goods. In another implementation, the network environment 100 may be a smaller private network. In yet another implementation, the network environment 100 may be a public network, such a public cloud.

For the purpose of simplicity of description, the CTS determination system 102 is hereinafter referred to as a system 102. The system 102 may be implemented in a variety of computing devices, such as a laptop computer, a desktop computer, a notebook, a workstation, a mainframe computer, a server, a network server, and the like. In one implementation, the system 102 may be included within an existing information technology infrastructure or a database management structure. Further, it will be understood that the system 102 may be connected to a plurality of user devices 104-1, 104-2, 104-3, . . . , 104-N, collectively referred to as the user devices 104 or as an individual user device 104. The user device 104 may include, but is not limited to, a desktop computer, a portable computer, a mobile phone, a handheld device, and a workstation. The user devices 104 may be used by users, such as database analysts, administrators, business users, finance and costing managers, supply chain managers, chief executive officers, chief financial officers, and the like, for operating the system 102.

As shown in the figure, the user devices 104 are communicatively coupled to the system 102 over a network 106 through one or more communication links for facilitating one or more end users to access and operate the system 102. In one implementation, the network 106 may be a wireless network, a wired network, or a combination thereof. The network 106 may also be an individual network or a collection of many such individual networks, interconnected with each other and functioning as a single large network, e.g., the internet or an intranet. The network 106 may be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include a variety of network devices, including routers, bridges, servers, computing devices, storage devices, and the like.

In an implementation, the system 102 may be coupled to a database 108 to obtain historical data related to the product and the customer. The database 108 may contain the data associated with the customer of the product of the CPG company and the product served to the customer by the CPG company. Although not shown in the figure, it will be understood that the database 108 may also be connected to the network 106 or any other network in the network environment 100. In an implementation, the database 108 may include various input files containing the historical data related to the product and the customer that may be used by the system 102. The input files may be generated manually for use by the system. In an implementation, the database 108 may include one of software, applications and products in data processing (SAP) system, enterprise resource planning (ERP) system, warehouse management system (WMS), transportation management system (TMS), other applications, and a combination thereof. The database 108 may be provided as a relational database and may store data in various formats, such as relational tables, object oriented relational tables, indexed tables. However, it will be understood that the database 108 may be provided as other types of databases, such as operational databases, analytical databases, hierarchical databases, and distributed or network databases. The data related to the customer and the product which is obtained from the database 108 is stored in input data 132.

The system 102 further includes interface(s) 110, for example, to provide the input data in a hierarchical manner. Further, the interface(s) 110 may include a variety of software and hardware interfaces, for example, interfaces for peripheral device(s), such as a keyboard, a mouse, an external memory, and a printer. Additionally, the interface(s) 110 may enable the system 102 to communicate with other devices, such as web servers and external repositories. The interface(s) 110 may also facilitate multiple communications within a wide variety of networks and protocol types, including wired networks, for example, LAN, cable, etc., and wireless networks, such as WLAN, cellular, or satellite. For the purpose, the interface(s) 110 may include one or more ports.

In an implementation, the system 102 includes processor(s) 112 coupled to a memory 114. The processor(s) 112 may be implemented as one or more microprocessors, microcomputers, microcontrollers, digital signal processors, central processing units, state machines, logic circuitries, and/or any devices that manipulate signals based on operational instructions. Among other capabilities, the processor(s) 112 may be configured to fetch and execute computer-readable instructions stored in the memory 114.

The memory 114 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. Further, the system 102 includes module(s) 116 and data 118. The module(s) 116 and the data 118 may be coupled to the processor(s) 112. The module(s) 116 include, for example, an input module 120, an allocation module 122, a determination module 124, a forecasting module 126, a dashboard creation module 128, and other module(s) 130. The other module(s) 130 may include programs or coded instructions that supplement applications or functions performed by the system 102.

The data 118 may include the input data 132, CTS data 134, forecasting data 136, and other data 138. The other data 138, amongst other things, may serve as a repository for storing data that is processed, received, or generated as a result of the execution of one or more modules in the module(s) 130. Although the data 118 is shown internal to the system 102, it may be understood that the data 118 can reside in an external repository (not shown in the figure), which may be coupled to the system 102. The system 102 may communicate with the external repository through the interface(s) 110 to obtain information from the data 118.

As mentioned earlier, the system 102 of the present subject matter may determine the total cost incurred by the CPG company in performing one or more activities associated with a product served to a customer. The one or more activities may be associated with at least one functionality for each of a plurality of organizational functions of the CPG company, relevant for determining the CTS. The plurality of organizational functions includes all the organizational functions that incur cost for serving the product to the customer.

In an implementation, for determining the total cost, the input module 120 may allow a user, such as an administrator or a business user, to provide an input with respect to at least one of a customer name and a product description, and a time period for which the total CTS is to be determined. For example, the user may provide the time period as half yearly, quarterly, monthly, and the like. Based on the received input, the input module 120 identifies the plurality of organizational functions that incur cost for serving the product to the customer. The plurality of organizational functions includes all the organizational functions that incur cost for serving the product by the CPG company and contribute to computation of the total CTS. The plurality of organization functions includes procurement of raw materials, manufacturing, distribution and logistics, and sales and promotion. Considering all such organizational functions facilitates in determining the total CTS of the product comprehensively.

Based on the inputs received from the user and identification of the plurality of organizational functions, the input module 120 retrieves historical data for the product and/or the customer, from the database 108. As mentioned earlier, the historical data may be understood as data related to a plurality of organizational functions performed by the CPG company to serve its products to its customers. The plurality of organizational functions, relevant for determining the CTS, may include procurement of raw materials, manufacturing, distribution and logistics, and sales and promotion. Further, each of the plurality of organizational functions may include at least one functionality, which in turn may include one or more activities associated thereto. In an implementation, the one or more activities, under the at least one functionality associated with the plurality of organizational functions, such as procurement of raw materials, manufacturing, distribution and logistics and sales and promotion, that incur costs may be defined and identified by the system 102 for the CPG company based on activity-based costing methodology.

In one implementation, the data may include bill of materials (BOM) for the product. The BOM for the product includes the raw materials that may be procured and used to make one unit of the product, cost of the raw materials for one unit of the product, total quantity of the raw materials for multiple units of the product to be served to the customer, and total cost of the raw materials for the multiple units of the product. The BOM also includes batch details for the product and the batch details for the raw material. Further, the batch details may include a batch number, a product name, a batch size, and raw material expense.

In another implementation, the historical data may be related to procurement data. The procurement data may be understood as the data related to the procurement function of the CPG company. The organizational function “procurement of raw materials” may include at least one functionality, such as vendor selection, requisition, and procurement strategy. Further, each of the at least one functionality of the organizational functions may be associated with one or more activities. In an example, the requisition functionality may include activities, such as resources-specification detailing and quantity planning, resources-approvals and confirmation, resources-vendor qualification, and resources-supplier accreditation.

Further, in an implementation the historical data may be data related to manufacturing, distribution, logistics, sales and promotion. In an example, the at least one functionality under the organizational function “manufacturing function” may include material costs, packaging costs, blending costs, and processing costs. Furthermore, the material costs functionality may include activities, such as direct material costs, indirect material costs, and import costs. In an implementation, the organizational function “distribution and logistics” may include sub-functions, such as warehousing-raw materials, warehousing-finished goods, distribution to customer warehouse and stores, and third-party logistics and distribution.

In another example, the at least one functionality under the “warehousing-raw materials” sub-function and the “warehousing-finished goods” sub-function may include, goods receipt, labeling and scanning, storage, cross-docking, shipping, sorting, operations, etc. In an implementation, to perform the goods receipt functionality, the one or more activities carried out by the CPG company, or its vendor, may include unloading of pallets, receipt entry, reconciliation, pallet tagging, scanning for putaway, and sorting for putaway.

In yet another example, the at least one functionality under the “distribution” sub-function and the “third party logistics” sub-function may include transportation, and direct store delivery. To perform the transportation functionality, the variety of activities carried out by the CPG company may include equipment rent, depreciation, insurance, garage rent, license and permits, petrol expenses, diesel expenses, and tolls.

Further, the at least one functionality under the organizational function “sales and promotion” may include sales, merchandising, and order management. To perform the sales functionality, the activities carried out by the CPG company may include travel, lodging and boarding. Accordingly, the historical data may include data related to each of the functionalities of the organizational functions “procurement of raw materials”, “manufacturing”, “distribution and logistics”, and “sales and promotion”. Further, the historical data as retrieved by the input module 120 may include data associated with each of the activities being performed in each of the functionalities. In an implementation, the input module 120 may store the historical data related to the product or the customer as input data 132.

Based on the retrieved historical data, the allocation module 122 identifies a total cost incurred by the CPG company for performing the one or more activities under each of the organizational functions associated with the serving of the product and relevant for determining the CTS. The total cost incurred for an activity, from amongst the one or more activities, may be understood as the cost incurred by the CPG company in performing that activity for the total quantity of the product served by the CPG company. In an implementation, the allocation module 122 may identify the total cost by activity based costing (ABC) method. The ABC method is a costing methodology which provides the total cost incurred in performing the one or more activities. For this, the ABC method decomposes the each of the plurality of organizational functions into the at least one functionality and further into the one or more activities. Then based on the activities, the ABC method decomposes the total cost incurred in performing the each of the organizational functions into the total cost incurred in performing the at least one functionality and then into the total cost incurred in performing the one or more functionalities.

Further, the total cost incurred in performing the one or more activities may be one of a variable cost and a fixed cost depending on type of the one or more activities. The variable cost is a cost which varies with output, such as change in number of units of products. For example, the variable cost may be a cost associated with raw materials, energy usage, labor, etc. When the number of products is varied, the amount of raw materials, the energy usage and the labor required varies. This variation results in variation of the costs associated with the each of these activities and hence, is termed as the variable cost. The fixed cost is a cost which remains substantially same with variation in the output, such as the change in the number of the units of the products. For example, the fixed cost may be a cost of a manufacturing plant and machinery, depreciation value of the machinery, insurance, interest, rent, salary and wages. When the number of products is varied, such costs tend to remain substantially the same and hence, are referred to as the fixed costs.

Based on the total cost, the allocation module 122 allocates cost attributable to the customer for the one or more activities under the each of the plurality of organizational functions, relevant for determining the CTS. For example, to allocate cost associated with the organizational function “procurement of raw materials”, the allocation module 122 may first identify the total cost incurred in performing the one or more activities associated with the at least one functionality of the organizational function “procurement of raw materials” for procuring all the raw materials for the entire quantity of the served product, and then allocate the cost attributable to the customer out from the total cost for the activity.

The allocation of the customer attributable costs by the allocation module 122 is based on predefined allocation criteria and the total cost of performing the one or more activities. The predefined allocation criteria dictate the proportion or the value out of the total cost which is incurred for serving the product to that customer. The proportion or the value of the total cost incurred for the customer and obtained based on the allocation criteria refers to the customer attributable costs. The predefined allocation criteria are provided in the system 102 by the user, such as the administrator. In an implementation, the predefined allocation criteria may be customized according to needs of the CPG company.

In an example, the predefined allocation criteria for the organizational function “procurement of raw materials” may be,

$$\frac{\begin{matrix}Purchase orders ( POs ) issued for procuring \\ raw materials for the customer\end{matrix}}{Total POs for procuring all the raw materials} \qquad ( 1 )$$

As shown in equation (1), the predefined allocation criteria are ratio of POs issued for procuring raw materials for the customer to the total POs for procuring all the raw material. When the ratio is multiplied with the total cost of performing the one or more activities under the organizational function “procurement of raw materials”, customer attributable cost is obtained for those one or more activities. The ratio clearly determines the part of the total cost to be attributed to the one or more activities.

The predefined allocation criteria may be different for the each of the one or more activities based on ratio between different parameters. In an implementation, the ratio may be defined to be 1:1 for an activity, from amongst the one or more activities. This makes the cost attributable to the customer for that activity same as the total cost of the activity. For example, if the CPG company sets up a centre for procurement of raw materials for the customer, then considering insurance of the centre as an activity, the total cost and the customer attributable cost are in a ratio of 1:1 and have the same value. The allocation of the customer attributable costs facilitates in determining the CTS value for the procurement of raw materials.

After allocating the costs, the determination module 124 computes a CTS value for each of the plurality of organizational functions based on the allocated costs attributable to the customer. The CTS value for one organizational function is determined by adding the customer attributable costs for the activities under that organizational function. The determination module 124 may store the CTS values for each of the plurality of organizational functions in the CTS data 134.

Further, based on the CTS value for each of the organizational functions, the determination module 124 computes a total CTS value of the product served to the customer. The total CTS value is the total cost incurred by the CPG company for performing the activities associated with the functionalities under the abovementioned organizational functions for serving the product to the customer. The total CTS value determined by the system 102 may also refer to the CTS value for the customer. By considering the costs incurred for various activities under the functionalities under the organizational functions, as mentioned earlier, the determined total CTS value is substantially accurate with respect to that evaluated using conventional methods. The determination module 124 may store the total CTS value for the customer and for the product served to the customer in the CTS data 134.

In an implementation, the determination module 124 may determine profitability of the customer based on the total CTS value for the customer. The determination module 124 may retrieve data related to net sales value of a product from the organizational function “sales and promotion” and determine a margin after CTS based on the net sales value and the total CTS value. In an example, the determination module 124 may compute net sales of the product in terms of percentage of total sales, the CTS values of each of the plurality of organizational functions as percentages of the total sales and the margin after CTS as percentage of sales. The profitability of the customer facilitates the CPG company in understanding the customer and the profitability associated with customer for the CPG company. The CPG company may, thus, have a clear insight of the profitability of serving the product to the customer. Based on the profitability of the customer, the CPG company may segregate its profitable and non-profitable customer. This may help the CPG company to eliminate non-profitable customers and retain profitable customers.

In an implementation, the system 102 may allow the user to perform what-if scenarios to reduce the CTS value for one or more organizational functions. In the context of the present subject matter, the what-if scenario enables to determine what is the CTS value if a particular raw material is procured, or if a particular mode of manufacturing is used, or if the products are stored and transported in a particular manner, or such. What-if scenario can be applied over any of the organizational functions, as mentioned herein. Based on the what-if scenario performed by the user, the determination module 124 may compute a revised CTS value for the one or more organizational functions, which may be less than that without applying the what-if scenario. The CTS may be reduced based on what-if scenario, without compromising on the contractual obligations of the CPG company to the customer.

In an example, in the BOM, the user may apply what-if scenario to provide his input to select between different raw materials for the product, and compute the CTS values for procurement and/or other organizational functions corresponding to different raw materials. A particular set of raw materials may result in a reduced CTS value for the procurement of raw materials, their storage and/or for manufacturing of the product. This may facilitate the CPG company in taking profitable decisions for the procurement of raw materials or other functions. In another example, the user may apply what-if scenarios to provide his input for selecting different number of pallets and eaches of the product that can be stored or warehoused, and may compute the CTS values for the organizational function “warehousing-finished goods”. A particular number of pallets and eaches may require less labor allocation, which may result in a reduced CTS for the warehousing-finished goods. This may facilitate the CPG company in determining an appropriate quantity of the pallets and eaches based on the labor allocation. The simulation through the what-if scenario facilitates the CPG company in making compelling offers to the right customers, and make the customers profitable for the CPG company.

In an implementation, the determination module 124 may check for relevancy and duplication of the data being considered for computation of the CTS. The determination module 124 may ensure that same data is not considered multiple times (under different organizational functions) to avoid any error in computation of the CTS. For example, considering a scenario where the CPG company may hire a third-party logistics for distribution of the products. The costs associated with activities, such as fuel expenses, will be considered under the organizational function “third party logistics”. The determination module 124 may ensure that the same costs are not mentioned again under the organizational function “distribution”. In an implementation, the determination module 124 may also prevent any such attempt, for example, double entry by an operator, of the CPG company. It may be understood that the check for duplication of data may not be applicable for a case where the CPG company adopts a hybrid model in which some activities are performed by the company on its own and similar activities are performed through a third party vendor hired by the company. With the hybrid model, the costs for the activities performed by the company and by the third party vendor are considered for determining the CTS values.

In an implementation, the forecasting module 126 may generate forecasts of the CTS based on the total CTS value for the customer and a predefined forecasting model. The predefined forecasting model may include, but is not limited to, a moving average model, a winter's model, and a causal model. The moving average method is an average of time series data, i.e., observations equally spaced in time, from several consecutive historical periods. The moving average is continually recomputed as new data becomes available. It progresses by dropping the earliest value and adding the latest value. The causal model is based on regression analysis of a relationship between a dependent variable, for example the total CTS value for the customer, and one or more independent variables, for example causal factors causing the change in the total CTS value. The winter's model is an exponential smoothing method used to forecast time series for which both trend and seasonality are present. In an implementation, the forecasting module 126 may store the CTS value forecasts as the forecasting data 136.

In an implementation, the dashboard creation module 128 may create dashboards based on the total CTS value computed for a product or a customer over a period of time. In an example, the dashboard creation module 128 may provide a dashboard for a CTS break-up among each of the plurality of organizational functions considered in the determination of CTS. In another example, the dashboard creation module 128 may provide a dashboard for a comparison of CTS revenue ratio of the customer with respect to multiple customers over a predetermined time period. In yet another example, the dashboard creation module 128 may provide a dashboard for a comparison of CTS values of a current quarter with a previous quarter. In an example, the dashboard creation module 128 may provide a dashboard for a comparison of the multiple customers based on the CTS values of each of the organizational functions.

The dashboard creation module 128 may also generate a heat map based on a ranking table of the multiple customers. The user may select the customer from the ranking table, and the dashboard creation module 128 may depict, in the heat map, the outlets of the customer along with the analysis of the outlets based on the CTS of each of the outlets of the customer. Such insights related to the CTS facilitate the CPG company in appropriate decision-making and proactive planning for serving its products to the customers. In an implementation, the dashboard may be customized for the CPG company.

As mentioned earlier, the system 102 is enabled to determine the CTS of a product-customer combination for the CPG company for a predetermined period of time, in accordance with the present subject matter. In an implementation, the predetermined time period may be one of monthly, quarterly, half-yearly, yearly, and the like, based on a user input.

In an implementation, the system 102 may provide user interfaces (UIs) to the users for executing the system 102 for determining the total CTS value for a customer. One UI may be provided to compute the CTS value for one organizational function. The user may be able to provide inputs to the system 102 through the UIs for determining the total CTS value, in accordance with the present subject matter.

In an example, a UI may be provided for the organizational function “procurement of raw material”. With the UI for procurement of raw material, the user may provide his inputs through an entry form. As described above, the inputs may include a name of a customer and/or a product description. The input may also include a predefined time period for which the user may like to obtain the total CTS value for a customer through the system 102. Based on the user input, the input module 120 may retrieve data from the database 108 to populate different sections of the UI displaying orders, units, procurement CTS and functionalities of procurement function. The sections may include fields, such as selection of raw material, purchase orders (POs), units dispatched to the customer, types of units, and the like. The functionalities may be represented as tables having row elements and columns, where the row elements of the tables may represent one or more activities performed for the product and the columns may represent total cost of the one or more activities, customer attributable cost, and CTS per unit.

In an example, the UI for procurement of raw material may allow the user to select ‘modified food starch’ as a raw material from a list of materials provided in a drop down menu on the UI. Thereafter, the input module 120 may populate the fields, such as customer units dispatched, PO's for raw materials for the customer, total PO's for the raw material. The total cost of the one or more activities for the functionalities for procurement are populated in the tables appropriately based on historical data. The allocation module 122 then allocates the customer attributable costs against each of the activities. The determination module 124 then computes the CTS value for the procurement function by adding the customer attributable costs filled against the activities under the procurement function.

In an implementation, the user may customize the data provided in the abovementioned sections based on their requirements. For example, the user may modify or delete values of the fields, such as customer units dispatched and PO's of raw materials for the customer. The user may also apply what-if scenarios, where the user may modify the set of raw materials or other input field to compute the revised CTS value. Through the what-if scenarios, the user can identify a scenario appropriate for achieving a reduced CTS value for the customer of the product depending on the requirement of the CPG company.

In an example, a UI may be provided for the organizational function “warehousing-finished goods”. The UI for warehousing-finished goods may include sections, such as labor allocation simulation section, finished goods section, warehousing cost to serve section, and functionalities associated with the warehousing-finished goods function. As the name suggests, the labor allocation simulation section may provide the number of pallet and eaches that may be warehoused by the CPG company. This may facilitate the user to apply what-if scenarios and determine the allocation of labor for the activities included in the organizational function “warehousing-finished goods”. For example, the user may modify or delete the value of fields ‘pallets’ and/or ‘eaches’, value of ‘labor allocation’ may automatically change to indicate the percentage of labor allocation required for the number of pallets and eaches specified.

In an implementation, the user may select the product, the store type, and the unit type from a drop down menu on the UI for warehousing-finished goods. The input module 120 based on the user inputs may retrieve the historical data from the database 108 and the total cost are populated appropriately in the sections representing activities for the warehousing-finished goods functionality. In an implementation, the data in the fields may be manually entered and may be modified by the user. Based on the total costs, the allocation module 122 allocates the customer attributable costs, and the determination module 124 then computed the CTS value for the warehousing-finished goods function, by adding the customer attributable costs filled against the activities under the warehousing-finished goods function.

In an example, a UI may be provided for the organizational function “distribution”. The UI for the distribution function may include various sections such as transportation details section, customer details section, distribution cost to serve section, and functionalities associated with the distribution function. In an implementation, the input module 120 may retrieve the historical data from the database 108 and populate the values of fields, such as units dispatched to the customer and total units dispatched during the period, based on the historical data. Further, the total costs are populated appropriately in the sections representing activities for the distribution functionality. Based on the total costs, the allocation module 122 allocates the customer attributable costs, and the determination module 124 then computed the CTS value for the distribution function, by adding the customer attributable costs filled against the activities under the distribution function.

Further, the UI for the distribution function may enable the users to vary the values of the fields, such as unit type and units dispatched to the customer. The user may also be able to apply what-if scenarios by varying the fields. When the user varies the value of the fields, the input module 120 populates total costs in the row elements of the tables representing the functionalities, the allocation module 122 allocates the customer attributable costs, and the determination module 124 computes the CTS value for the distribution function.

In an example, a UI may be provided for the organizational function “sales and promotion”. The UI for the sales and promotion function may include sections such as stores, promotions, kiosk, customer details, sales and promotion cost to serve (CTS), display, signage and banner, and functionalities associated with the sales and promotion function. In an implementation, the input module 120 may retrieve the historical data from the database 108 and populate the data in each of the sections. Further, the total cost are populated appropriately in the sections representing activities for the sales and promotion functionality. Based on the total costs, the allocation module 122 allocates the customer attributable costs, and the determination module 124 then computed the CTS value for the sales and promotion function, by adding the customer attributable costs filled against the activities under the sales and promotion function.

In an implementation, the UI for the sales and promotion function may allow the user to modify or delete values of the fields, such as stores served, number of shelves per store, shelf management hourly rate, number of bill backs of the customer and kiosk hourly labor rate, in the UI for the sales and promotion function. With this the user may apply the what-if scenarios. Through these what-if scenarios, the user may identify an appropriate scenario for a reduced CTS for the customer depending on the requirement of the CPG company.

In an example, a UI may be provided for customer profitability analysis. The UI for the customer profitability analysis may include tables for estimating customer profitability. The tables may include a table capturing the CTS value for each of the organizational functions and the total CTS value, and a table capturing the CTS per unit for each of the organizational functions.

In the table capturing the CTS value for each of the organizational functions, the determination module 124 may populate the table with the values of the CTS for the each of the organizational functions. The determination module 124 may also compute net sales as percentage of total sales, the CTS as percentage of sales, cost of goods sold, gross margin, total CTS, margin after CTS and margin as percentage of sales, based on the CTS values of the each of the plurality of the organizational functions. These values may be provided to the user through the UI for the customer profitability analysis.

In the table capturing the CTS per unit for each of the organizational functions, the determination module 124 may compute the sum of cost per unit for each of the organizational functions and may populate the table with these values. The determination module 124 may also compute the CTS per unit as percentage of sales and total CTS per unit. The determination module 124 may populate the table with the values of net sales as percentage of total sales, the CTS as percentage of sales, the cost of goods sold, the gross margin, the total CTS, the margin after CTS and the margin as percentage of sales in the UI for the customer profitability analysis. The UI for the customer profitability analysis provides analysis of the customer, and a comparative analysis of the customer with multiple customers. This facilitates the CPG company in determination of the customer profitability.

In an example, a UI may provide dashboards to the user. The UI for dashboards may include a cost break-up for a customer; a comparison of multiple customers based on a CTS revenue ratio over a period of time, for example, from quarter 1 to quarter 4; a comparison of multiple customers based on total CTS values over two different periods of time, for example, quarter 1 of 2012 and quarter 1 of 2011; a comparison of the multiple customers based on the CTS value of each of the organizational functions, and a heat map. The heat map is based on a ranking table of the multiple customers. When the user selects the customer from the ranking table the heat map depicts the outlets of the customer. The heat map also depicts analysis of the outlets of the customer based on the total CTS value for the customer.

In an example, a UI may be provided for CTS forecast for the customer. The forecasting module 126 may compute the forecast based on a predefined forecasting model and historical data. The forecasting module 126 may represent forecasted values and historical data in a tabular and graphical representation on the UI for the CTS forecast. The predefined forecasting model may include, but is not limited to, a moving average model, a winter's model and a causal model.

In an implementation, the predefined forecasting model is the moving average model, and the historical data for the CTS forecast includes data for previous years, quarters corresponding to each of the previous years, and total cost to serve (CTS) for the each of the quarters. Based on the historical data and the moving average model, the forecasting module 126 may forecast the total CTS for current year and/or future years. Based on the total CTS forecasts for current year and future years, the forecasting module 126 may generate a time series variation of the total CTS forecasts. In an implementation, the user may define a time period, based on which the forecasting module 126 may generate the forecasts.

In an example, for CTS forecasting through the moving average model, the forecasting module 126 may forecast the total CTS value of a product served to a customer for the quarters of 2013 based on the total CTS values for the quarters of 2008 to the quarters of 2012. The total CTS values for the quarters of 2008 to the quarters of 2012 may be the time series data for the moving average. The moving average of four-quarter total CTS may be computed by taking the average of the total CTS from quarter 1 to quarter 4 of year 2008, then the average of the total CTS from quarter 2 of 2008 to quarter 1 of 2009, then of quarter 3 of 2008 to quarter 2 of 2009, and so on. In another example, the forecasting module 126 may compute moving average of the CTS values to recognize changes in the CTS values associated with each of the organizational functions of the CPG company.

In an implementation, the predefined forecasting model is a causal model. With this model, the forecasting module 126 may forecast the total CTS for a time period, as may be defined by the user. The forecasting module 126 may tabulate the total CTS of previous years, forecasted total CTS, consumer price index, labor index, and fuel index for the customer. In an example, the forecasting module 126 establishes a mathematical relationship between the total CTS forecast and causal factors that cause change in the CTS values. The causal factors may include increase in raw material prices, increase in crude oil prices, and such, which may affect the future value of CTS for the organizational function, and hence the future value of total CTS for the customer. The forecasting module 126 may determine a time series variation of relationship of the total CTS value with respect to the causal factors based on regression analysis. In an example, the time series variation of the total CTS value with respect to causal factors may be represented as an equation for a straight line. Based on the time series variation, the CTS value can be forecasted for a particular time period, as defined by the user.

In an implementation, the above mentioned UIs are such that when the user varies the values of the fields, the input module 120, the allocation module 122, and the determination module 124 may be executed automatically and simultaneously to change the data in the appropriate sections on the UIs, and determine the CTS values.

FIG. 2 illustrates a method 200 for determining total cost to serve a product to a customer associated with a CPG company, in accordance with an implementation of the present subject matter. The method 200 can be implemented in the CTS determination system 102. The order in which the method 200 is described is not intended to be construed as a limitation, and any number of the described method blocks can be combined in any order to implement the method 200, or any alternative methods. Additionally, individual blocks may be deleted from the method 200 without departing from the spirit and scope of the subject matter described herein. Furthermore, the method 200 can be implemented in any suitable hardware.

The method 200 may be described in the general context of computer executable instructions. Generally, computer executable instructions can include routines, programs, objects, components, data structures, procedures, modules, functions, etc., that perform particular functions or implement particular abstract data types. Further, although the method 200 may be implemented in any computing device; in an example described in FIG. 2, the method 200 is explained in context of the aforementioned CTS determination system 102, for the ease of explanation.

Referring to FIG. 2, at block 202, the method 200 may include retrieving historical data from a database 108. The historical data may be understood as data related to the plurality of the organizational functions for multiple customers and multiple products of the CPG company. In an implementation, the historical data may include a bill of materials (BOM) for the product, procurement data, manufacturing data, distribution and logistics data, and sales and promotion data. In an implementation, the historical data is retrieved by the input module 120. In the implementation, the input module 120 may receive an input from the user for determining the total cost incurred by the CPG company. The input may include a customer name, a product description, and a time period for which the determination is to be performed. Before retrieving the historical data, the plurality of organizational functions may be identified. The plurality of organizational functions comprises all organizational functions that incur cost for serving the product to the customer by the CPG company. The plurality of organization functions includes procurement of raw materials, manufacturing, distribution and logistics and sales and promotion.

At block 204, the method 200 may include identifying a total cost incurred by the CPG company for a product in each of a plurality of organization functions that incur cost for serving the product. In an implementation, the plurality of organizational functions comprises at least one functionality having one or more activities associated therewith. In an implementation, the allocation module 122 may identify the total cost from the historical data. Further, the total cost may include a variable cost and a fixed cost associated with the product in each of the plurality of organizational functions.

At block 206, the method 200 may include allocating cost attributable to a customer for the one or more activities. In an implementation, the allocation module 122 may allocate the attributable cost to the customer. The allocation of the cost attributable to the customer may be based on predefined allocation criteria and the total cost incurred by the CPG company in performing the one or more activities associated with the serving of the product. The predefined allocation criteria may be set by an administrator. In an implementation, the predefined allocation criteria may be customized according to the requirements of the CPG company.

At block 208, the method 200 may include computing a CTS value for each of the plurality of organizational functions. In an implementation, the determination module 124 may compute the CTS value based on the allocated cost attributable to the customer. In an implementation, the user may apply what-if scenarios for one or more of the organizational functions to compute a reduced CTS value for the one or more organizational functions, without compromising on the contractual obligations of the CPG company to the customer. The what-if scenarios, for example, include determination of raw materials in a bill of materials (BOM) for the product, simulation of labor allocation for the distribution and logistics, etc. The CTS value for the organization function may be computed based on the reduced CTS value based on the what-if scenarios.

Further, at block 210, the method 200 may include determining a total CTS of the product served to the customer associated with the CPG company. The determination module 124 may determine the total CTS based on the CTS value determined for each of the plurality of the organizational functions. Based on the total CTS and a net sales value associated with the product and the customer, the determination module 124 may determine customer profitability. In an implementation, based on the total CTS, dashboards may be generated for the customer over a period of time. The dashboard may include information pertaining to CTS break-up among the each of the plurality of organizational functions, a comparison of multiple customers based on CTS revenue ratio of the customer with respect to the multiple customers, the CTS values of each of the multiple customers over a period of time, a comparison of CTS values of a current quarter with a previous quarter, a ranking of the customers based on the CTS values and a heat map.

At block 212, the method 200 may include generating forecasts related to the total CTS of the product for the customer based on a predefined forecasting model and the historical data. In an implementation, the forecasting module 126 may generate CTS forecasts for the customer. The predefined forecasting model may include, but is not limited to, a moving average model, a winter's model, and a causal model.

Although implementations for system(s) and method(s) for determination of the total CTS of the product served to the customer is described, it is to be understood that the present subject matter is not necessarily limited to the specific features or methods described. Rather, the specific features and methods are disclosed as implementations to determine the total CTS of the product served to the customer.

I/We claim:

1. A computer-implemented method for determining total cost to serve (CTS) a product to a customer associated with a consumer packaged goods (CPG) company, the method comprising:
identifying, by a processor, a total cost associated with the product and incurred by the CPG company in each of a plurality of organizational functions of the CPG company, wherein each of the plurality of organizational functions incurs cost for serving the product and comprises at least one functionality having one or more activities associated therewith, and wherein the total cost is retrieved from a database;
based on the total cost, allocating, by the processor, cost attributable to the customer for the one or more activities under each of the plurality of organizational functions, wherein the allocation is based on predefined allocation criteria;
computing, by the processor, a CTS value for each of the plurality of organizational functions based on the allocated cost attributable to the customer; and
determining, by the processor, the total CTS of the product served to the customer of the CPG company, wherein the determining includes summing up the CTS values for each of the plurality of organizational functions.

2. The computer-implemented method as claimed in claim 1, wherein the computing the CTS value for the plurality of organizational functions comprises computing a reduced CTS value for at least one of the plurality of organizational functions based on what-if scenarios provided by a user, in concurrence with contractual obligations of the CPG company in serving the product to the customer.

3. The computer-implemented method as claimed in claim 2, wherein the computing of the reduced CTS value, based on the what-if scenarios, comprises receiving a user input to vary at least one cost-incurring attribute of the at least one of the plurality of organizational functions, wherein the at least one cost-incurring attribute comprises a raw material selected for procurement, quantity of raw material selected for procurement, mode of manufacturing the product, number of pallets and eaches selected for warehousing, number of stores served, and number of shelves per store.

4. The computer-implemented method as claimed in claim 1, wherein the allocating comprises computing a fixed cost and a variable cost associated with the product based on the total cost.

5. The computer-implemented method as claimed in claim 1 further comprising identifying the plurality of organizational functions, wherein the plurality of organizational functions comprises all organizational functions that incur cost for serving the product to the customer by the CPG company.

6. The computer-implemented method as claimed in claim 1, wherein the plurality of organizational functions comprises procurement of raw materials, manufacturing, distribution and logistics, and sales and promotion, wherein the distribution and logistics comprises warehousing-raw materials, warehousing-finished goods, distribution to customer warehouse and stores, and third-party logistics and distribution.

7. The computer-implemented method as claimed in claim 1, wherein the identifying comprises:
receiving input from a user, wherein the input comprises at least one of a customer name and a product description, and a time period for determining the total CTS; and
retrieving historical data related to the CPG company from the database, based on the input.

8. The computer-implemented method as claimed in claim 1 further comprising identifying, by the processor, cost associated with the one or more activities under the at least one functionality associated with the each of the plurality of organizational functions, based on activity based costing, wherein the allocating comprises allocating cost attributable to the customer for the product under the one or more activities.

9. The computer-implemented method as claimed in claim 1 further comprising generating, by the processor, at least one dashboard for,
providing CTS break-up among the plurality of organizational functions; and
comparing multiple customers based on at least one of CTS revenue ratio and the total CTS for each of the multiple customers over a time period.

10. The computer-implemented method as claimed in claim 1 further comprising determining, by the processor, customer profitability based on the total CTS and a net sales value associated with the product and the customer.

11. The computer-implemented method as claimed in claim 1 further comprising generating forecasts, by the processor, related to the total CTS of the product served to the customer based on a pre-defined forecasting model and a historical data of the customer.

12. The computer-implemented method as claimed in claim 11, wherein the pre-defined forecasting model comprises one of a moving average model, a winter's model, and a causal model.

13. A cost to serve (CTS) determination system for determining total cost to serve a product to a customer associated with a consumer packaged goods (CPG) company, the CTS determination system comprising:
a processor;
input module, coupled to the processor, to,
receive input from a user, wherein the input comprises at least one of a customer name and a product description, and a time period for determining the total CTS; and
based on the input, retrieve historical data from a database; and
an allocation module, coupled to the processor, to,
based on the historical data, identify a total cost associated with the product and incurred by the CPG company in each of a plurality of organizational functions of the CPG company, wherein each of the plurality of organizational functions incurs cost for serving the product and comprises at least one functionality having one or more activities associated therewith; and
based on the total cost, allocate cost attributable to the customer for the one or more activities under each of the plurality of organizational functions, wherein the allocation is based on a predefined allocation criteria; and
a determination module, coupled to the processor, to,
compute, a CTS value for the each of the plurality of organizational functions based on the allocated cost attributable to the customer; and
determine, the total CTS of the product served to the customer of the CPG company, wherein the determination includes summing up the CTS values for each of the plurality of organizational functions.

14. The CTS determination system as claimed in claim 13, wherein the determination module computes a reduced CTS value for at least one of the plurality of organizational functions based on what-if scenarios provided by a user, and determines the total CTS based on the reduced CTS value.

15. The CTS determination system as claimed in claim 13, wherein the allocation module further identifies the one or more activities under the at least one functionality associated with the each of the organizational functions, based on activity based costing, and allocates cost attributable to the customer for the product under the one or more activities.

16. The CTS determination system as claimed in claim 13, wherein the determination module checks for duplication of the historical data retrieved from the database.

17. The CTS determination system as claimed in claim 13, wherein the determination module further determines customer profitability based on the total CTS and a net sales value associated with the product and the customer.

18. The CTS determination system as claimed in claim 13 further comprising a dashboard creation module, coupled to the processor, for generating at least one dashboard to:
provide CTS break-up among the plurality of organizational functions; and
compare multiple customers based on at least one of CTS revenue ratio and the total CTS for each of the multiple customers over a time period.

19. The CTS determination system as claimed in claim 13 further comprising a forecasting module, coupled to the processor, to generate a forecast for the total CTS of the product served to the customer based on the historical data of the customer and a predefined forecasting model.

20. A non-transitory computer readable medium having a set of computer readable instructions that, when executed, cause a computing device to determine total cost to serve (CTS) a product to a customer associated with a consumer packaged goods (CPG) company, the set of computer readable instructions, when executed, cause the computing device to:
identify a total cost associated with the product and incurred by the CPG company in each of a plurality of organizational functions of the CPG company, wherein each of the plurality of organizational functions incurs cost for serving the product to the customer and comprises at least one functionality having one or more activities associated therewith, and wherein the total cost is retrieved from a database;
based on the total cost, allocate cost attributable to the customer for the one or more activities under each of the plurality of organizational functions, wherein the allocation is based on predefined allocation criteria;
compute a CTS value for each of the plurality of organizational functions based on the allocated cost attributable to the customer; and
determine the total CTS of the product served to the customer of the CPG company, wherein the determining includes summing up the CTS values for each of the plurality of organizational functions.
